(19) United States
(12) Patent Application Publication
(10) Pub. No.: US 2005/0259994 A1
(43) Pub. Date: Nov. 24, 2005

(54) Optical transceiver module having improved printed circuit board

(76) Inventors: Chao Zhang, Chengdu (CN); Yuanjun Huang, Chengdu (CN); Qing Huang, Chengdu (CN); Zhiyong Jiang, Chengdu (CN); Qiuming Wei, Chengdu (CN)

Correspondence Address: Xin Wen, 3449 Rambow Drive, Palo Alto, CA, 94306, US

(21) Appl. No.: 10/850,216

(22) Filed: May 20, 2004

(51) Int. Cl. H04B 10/00

(52) U.S. Cl. 398/164

(57) ABSTRACT

An optical transceiver module includes a first Printed Circuit Board having a first function circuit connected with the electrical interface and a second Printed Circuit Board having a second function circuit that is electrically connected with the first function circuit. The second Printed Circuit Board is disposed substantially perpendicular to the first Printed Circuit Board.

### CROSS-REFERENCES TO RELATED INVENTIONS

The present invention is related to commonly assigned U.S. patent application Ser. No. 10/741,805, filed on Dec. 19, 2003, titled “Bi-directional optical transceiver module having automatic-restoring unlocking mechanism”, commonly assigned U.S. patent application Ser. No. 10/815,326, filed on Apr. 1, 2003, titled “Small form factor pluggable optical transceiver module having automatic-restoring unlocking mechanism and mechanism for locating optical transceiver components”, and commonly assigned Chinese Patent Application No. 200420033096.3 filed on Mar. 4, 2004, titled “Printed Circuit Board for Small Form Factor Optical Transceiver”. The disclosures of this related application are incorporated herein by reference.

### TECHNICAL FIELD

This disclosure relates to electro-optical devices, specifically, optical transceiver modules for telecommunication and data communication applications.

### BACKGROUND

Computers are increasingly being connected to communication lines and other devices or networks with the computers performing as servers to the peripherally connected computers or devices. The volume of data sent and received by the computer serving as a server of a network is such that the networks are advantageously constructed using fiber optic lines in order to increase the throughput of data.

Fiber optic lines and the associated fiber optic signals require transceivers to convert the optical light pulse signals to electronic signals which are usable by the computer. Such a transceiver includes a transmitter optical component and a receiver optical component to send and receive the optical signals. Modem optical transceivers have been modularized with standard physical sizes, under standard electrical interface agreements and standard optical interface agreements. One of such standard agreements is the Small Form-factor Pluggable Multi-Source Agreement (SFP MSA).

A Printed Circuit Board (PCB) is a major component of an optical transceiver module. All transmission and reception circuits are built on this Printed Circuit Board. In the modem telecommunication and data communication applications, the dimension of an optical transceiver module is getting smaller and the optical transceiver module is required to support more functions. However, the limited usable area of a PCB makes function extension difficult. It is therefore desirable for a Printed Circuit Board to hold more functions for a fixed working space. Additionally, it is also desirable to reduce electromagnetic interference between different parts of a Printed Circuit Board.

### SUMMARY

In one aspect, optical transceiver module is disclosed, comprising

a housing comprising a first end and a second end;

an electrical interface associated with the first end, said electrical interface being adapted to be locked into a socket of a receiving cage;

an optical interface associated with the second end, said optical interface adapted to be connected with one or more optical transceiver components;

a first Printed Circuit Board having a first function circuit connected with the electrical interface; and

a second Printed Circuit Board having a second function circuit that is electrically connected with the first function circuit,

wherein the second Printed Circuit Board is disposed substantially perpendicular to the first Printed Circuit Board.

In another aspect, an optical transceiver module is disclosed, comprising

a housing comprising a first end and a second end;

an electrical interface associated with the first end, said electrical interface being adapted to be locked into a socket of a receiving cage;

an optical interface associated with the second end, said optical interface adapted to be connected with one or more optical transceiver components; and

a Printed Circuit Board (PCB) module, comprising a first Printer Circuit Board having a first function circuit; and a plurality of second Printed Circuit Boards each comprising a second function circuit that are electrically connected to the first function circuit.

In yet another aspect, an optical transceiver module is disclosed, comprising a housing comprising a first end and a second end;

an electrical interface associated with the first end, said electrical interface being adapted to be locked into a socket of a receiving cage;

an optical interface associated with the second end, said optical interface adapted to be connected with one or more optical transceiver components;

a first Printed Circuit Board having a first function circuit connected with the electrical interface; and

a multi-layer second Printed Circuit Board comprising a second function circuit in the multi-layer structure, wherein the second Printed Circuit Board is electrically connected with the first function circuit.

Embodiments may include one or more of the following advantages. The PCB area is increased using a second PCB in addition to the first PCB. The two PCBs fit the same modular physical dimensions. This solution provides an optical transceiver module manufacturer the freedom of increase the functions of its optical transceiver module without developing new IC designs, which can reduce development time and be very cost effective.

The disclosed system also include one or more of the following advantages. The second Printed Circuit Board can divide the first Printed Circuit Board into two circuit areas. The transmission circuits are laid out in one circuit area while the reception circuits in another. The second Printed Circuit Board can provide electromagnetic shielding and thus minimize electromagnetic interference between the transmission path and the reception path.

The system disclosed increases functionality of the optical transceiver module while still being compatible with industry standards. The disclosed optical transceiver module is robust and reliable.

### DESCRIPTION OF DRAWINGS

FIG. 1 is a perspective view of the optical transceiver module in accordance with the present invention.

FIG. 2 is a blown up cross-sectional view of the mechanical structure of the optical transceiver module in accordance with the present invention.

FIG. 3 is a perspective view of the PCB, together with the optical transceiver components soldered to the PCB inside the case body of FIG. 1.

FIG. 4 is a perspective view of the PCB, with the optical transceiver components connected to the PCB through a flexible PCB inside the case body of FIG. 1.

FIG. 5 is one implementation of the connection between the first PCB and the second PCB.

FIG. 6 is another implementation of the connection between the first PCB and the second PCB.

FIG. 7 is yet another implementation of the connection between the first PCB and the second PCB.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Computers are increasingly being connected to communication lines and other devices or networks with the computers performing as servers to the peripherally connected computers or devices. The volume of data sent and received by the computer serving as a server of a network is such that the networks are advantageously constructed using fiber optic lines in order to increase the throughput of data.

Fiber optic lines and the associated fiber optic signals require transceivers to convert the optical light pulse signals to electronic signals which are usable by the computer. Such a transceiver includes a transmitter optical component and a receiver optical component to send and receive the optical signals. Modern optical transceivers have been modularized with standard physical sizes, under standard electrical interface agreements and standard optical interface agreements. One of such standard agreements is the Small Form-factor Pluggable Multi-Source Agreement (SFP MSA).

A Printed Circuit Board (PCB) is a major component of an optical transceiver module inside the module's case body. Transmission and reception circuits are commonly built on this Printed Circuit Board. In modern telecommunication and data communication applications, the dimensions of optical transceiver modules continually decrease. The optical transceiver modules are required to support more functions on limited or decreasing PCB areas.

In one aspect, developments in telecommunication and data communication require more and more functions be included on the PCB of an optical transceiver module. But the modular shape of an optical transceiver module and its corresponding interface agreement limit the usable area of the PCB. One possible solution for this usable area limitation problem is to decrease the Integrated Circuit (IC) chip sizes on the PCB by using a newer and more advanced IC technology with deeper sub-micron transistors. Another solution is to combine functions on different IC chips into one single IC, making a System-on-a-Chip (SOC) IC. These solutions however rely on the developments of new IC chips, which is costly and time consuming.

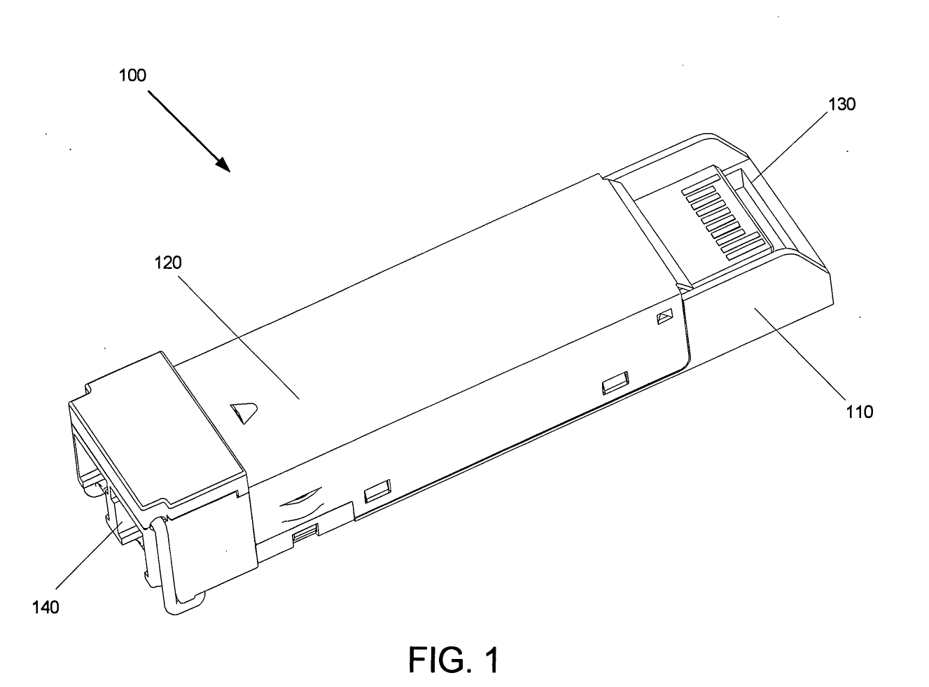

FIG. 1 is a perspective view of an optical transceiver module 100 comprising a case body 110, a sheet metal cover 120, a first end 130 associated with an electrical interface including one or more Printed Circuit Boards (PCBs), and a second end 140 associated with an optical interface.

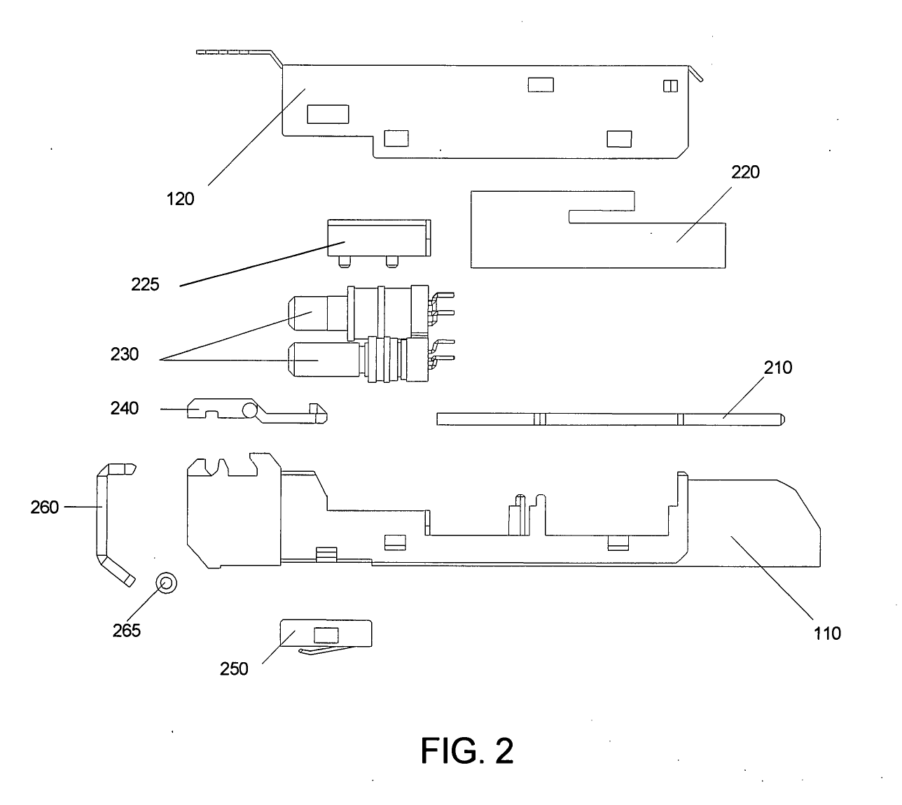

FIG. 2 is a blown up cross-sectional view of the structure of the optical transceiver module 100. Inside the optical transceiver module 100 are the first Printed Circuit Board 210, the second Printed Circuit Board 220, retainer 225, and one or two optical transceiver components 230. Also shown in FIG. 2 are the case body 110, the sheet metal cover 120, an upper cover 240, a lower cover 250, an unlocking lever 260 and a case pipe 265. Details of the structures and operations of various components of the optical transceiver module 100 are described in U.S. patent application Ser. No. 10/741,805 filed on Dec. 19, 2003, titled “Bi-directional optical transceiver module having automatic-restoring unlocking mechanism” and commonly assigned U.S. patent application Ser. No. 10/815,326, filed on Apr. 1, 2003, titled “Small form factor pluggable optical transceiver module having automatic-restoring unlocking mechanism and mechanism for locating optical transceiver components”. The content of these patent applications are herein incorporated by reference.

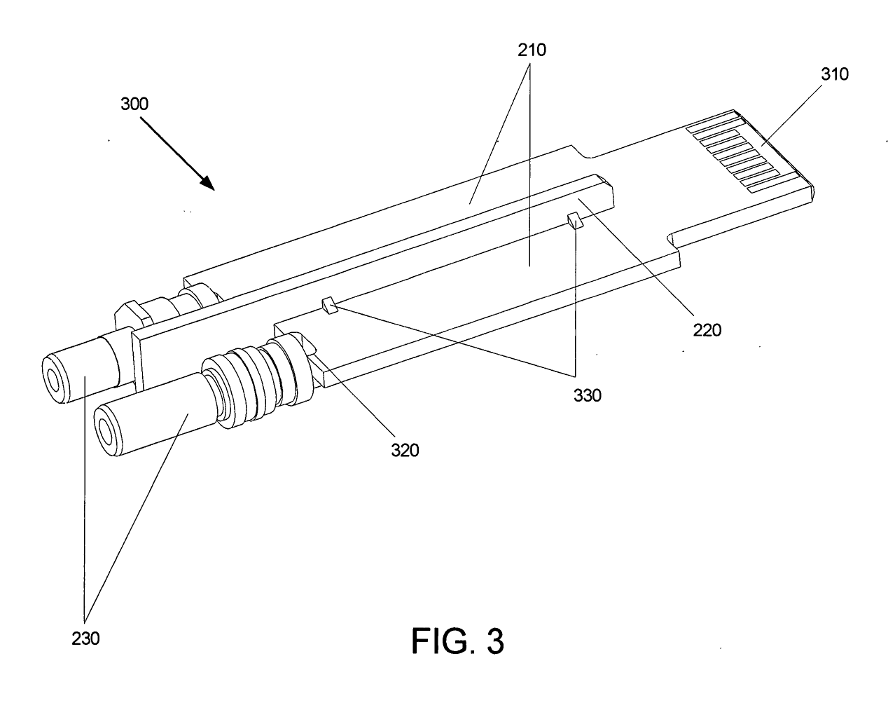

FIG. 3 is a perspective view of the PCB 300 of the optical transceiver module 100 assembled together with one or more optical transceiver components 230. The PCB 300 comprises a first Printed Circuit Board 210, and a second Printed Circuit Board 220 that is disposed substantially perpendicular to the first Printed Circuit Board 220. The PCB 300 also includes a first end 310 associated with the electrical interface and a second end 320 for the connections of one or more optical transceiver components 230. The optical transceiver components 230 are connected to the first PCB by having the signal pins of the optical transceiver components 230 soldered to the optical interface 320 of the PCB 300.

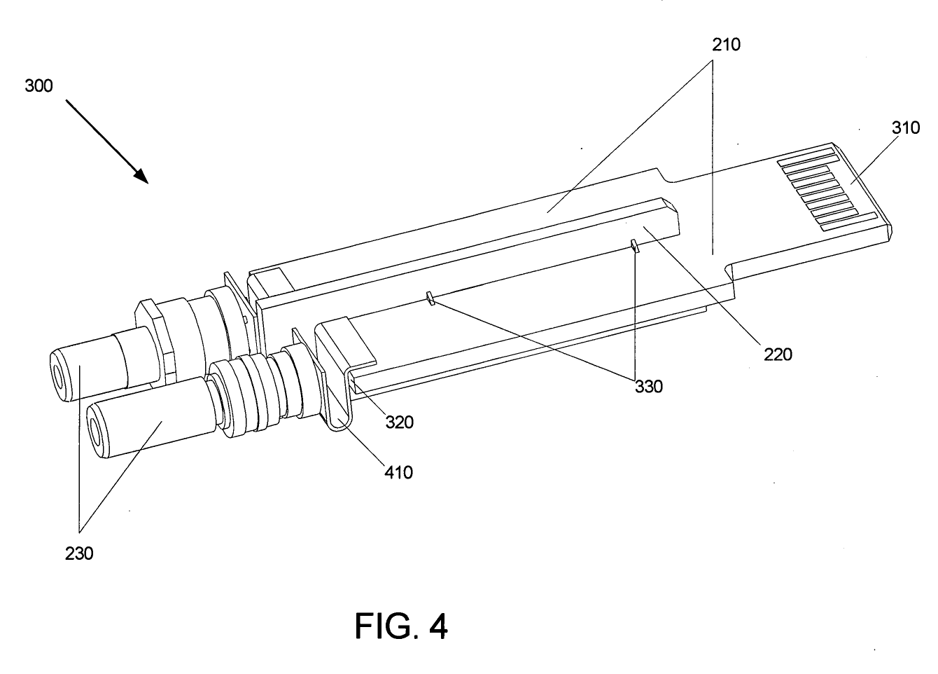

In another embodiment, as shown in FIG. 4, the optical transceiver components 230 are connected to the first PCB 210 through a flexible Printed Circuit Board 410. If the signal pins of the optical components 230 are connected directly to the first PCB 210, the fixed size of the case body 110 makes it difficult to fit the same sized first PCB 210 with different sized optical components 230 from different manufacturers. For a small sized optical component 230 to be connected to the first PCB 210, the signal pins have to be very long, resulting in a larger than necessary electronic capacity. The flexibility of the flexible PCB 410 solves this problem by bending the flexible PCB 410 in the desired way thus connecting the optical components 230 with shorter signal pins.

A Printed Circuit Board is typically a flat board that holds integrated circuit chips and other electronic components. The board comprises multiple layers (typically 2 to 10) of electronic components that are interconnected via metallic pathways. The first Printed Circuit Board 210 n a system is called a “system board” or “motherboard,” while smaller ones that plug into the slots in the first board are called “boards” or “cards.” In one embodiment, the first Printer Circuit Board 210 having a first function circuit is connected to a plurality of second Printed Circuit Boards 220 each comprising a second function circuit that are electrically connected to the first function circuit.

As shown in FIGS. 3 and 4, the second PCB 220 is connected to the first PCB 210 and is disposed perpendicular to the first PCB 210. Circuitry for primary functions of the optical transceiver module is built on the first PCB 210, while circuitry for secondary functions is built on the second PCB 220. With the second PCB 220, the total usable area of the Printed Circuit Board is increased. The percentage of the increase in the usable area of the Printed Circuit Board depends on the aspect ratio between the height and the width of the interior space inside the case body of the optical transceiver module 100. The higher the ratio is, the higher the percentage of the increased usable area is.

The first PCB 210 and the second PCB 220 can be connected in different arrangements. In one embodiment, the first Printed Circuit Board 210 is a mother board and the second Printed Circuit Board 220 a daughter board as specified by the ISA (Industry Standard Architecture) requirements for a daughter board on a mother board. In another embodiment, as shown in FIG. 3 and FIG. 4, the two Printed Circuit Boards are joined together permanently. A rabbet is first made on one or both of the Printed Circuit Boards 210 and 220. The Printed Circuit Boards 210 and 220 are then joined by sliding into each other's rabbet(s). The width of a rabbet on the first Printed Circuit Board must be equal to or slightly bigger than the thickness of the second Printed Circuit Board. Similarly, the width of a rabbet on the second Printed Circuit Board is required to be equal to or slightly bigger than the thickness of the first Printed Circuit Board. Printed Circuit Boards 210 and 220 are finally soldered together at the solder joints 330 to finish the connection.

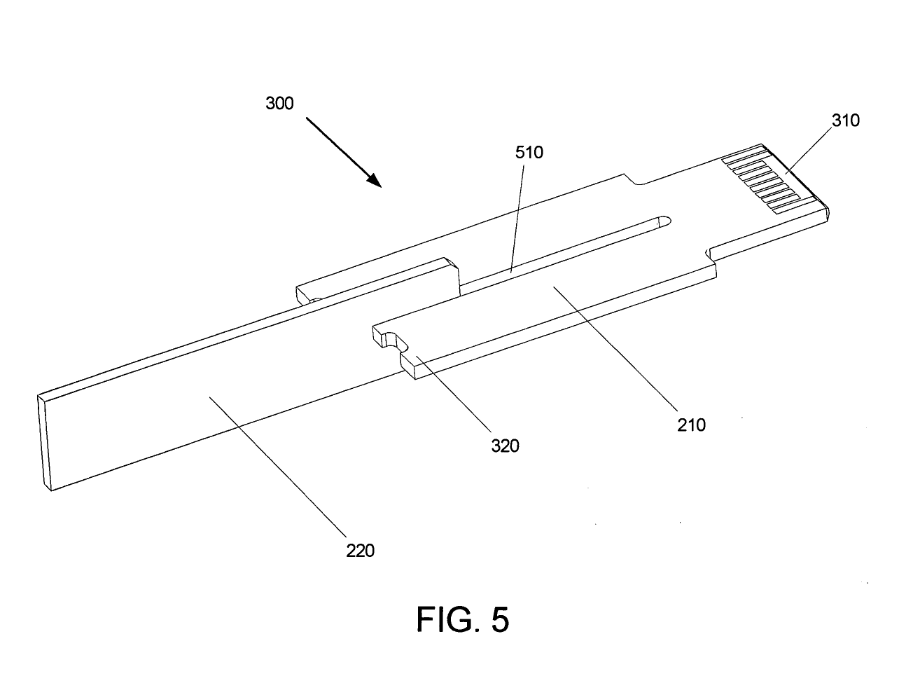

In another embodiment, as shown in FIG. 5, a rabbet 510 is provided on the second end 320 of the first Printed Circuit Board 210. The length of the rabbet 510 is long enough to receive the second Printed Circuit Board 220. In assembly, the second Printed Circuit Board 220 slides into the rabbet 510 to join the first Printed Circuit Board 210. Then first Printed Circuit Board 210 and the second Printed Circuit Board 220 are soldered together to make the two Printed Circuit Boards join each other permanently.

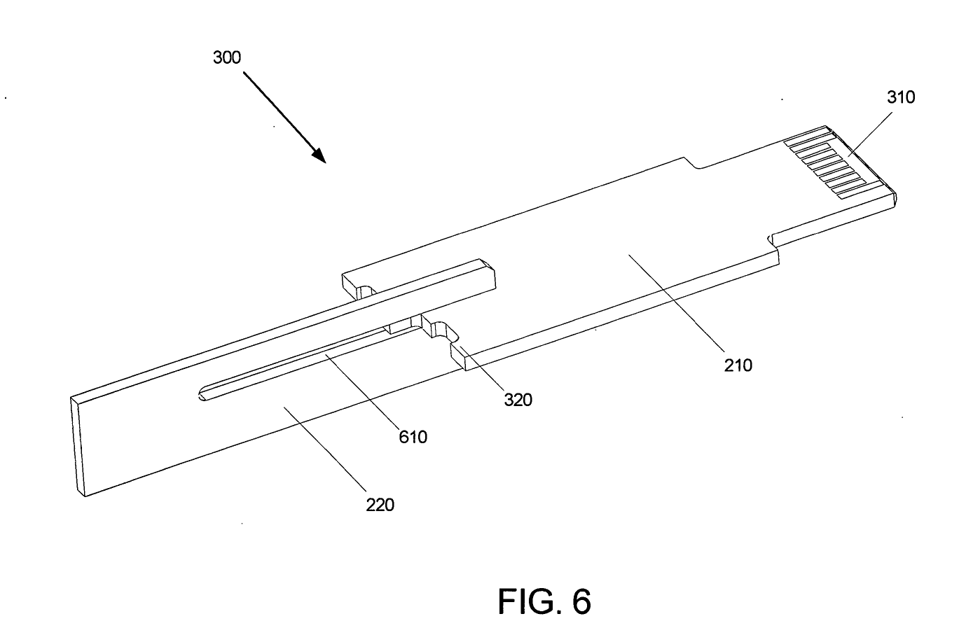

Another implementation is shown in FIG. 6. A rabbet 610 is cut on the first end of the second Printed Circuit Board 220. The first Printed Circuit Board 210 is slid into the rabbet 610 to join the second Printed Circuit Board 220. Then the two Printed Circuit Boards can be soldered together to make the two Printed Circuit Boards join each other permanently.

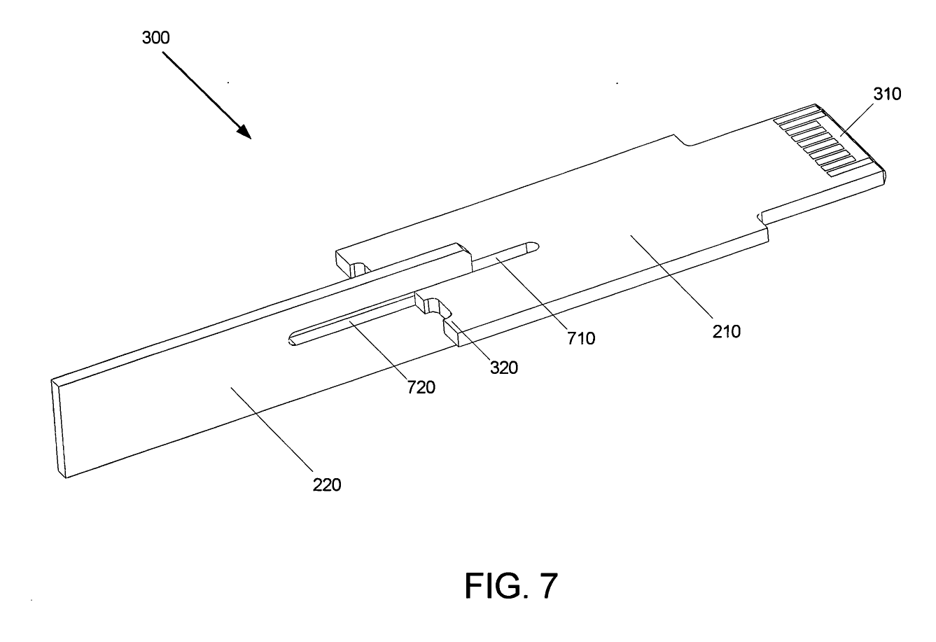

Yet another implementation is shown in FIG. 7. A rabbet 710 is cut on the second end of the first Printed Circuit Board 210, and a rabbet 720 is cut on the first end of the second Printed Circuit Board 220. The two rabbets 710 and 720 are cut long enough to allow the first Printed Circuit Board 210 and the second Printed Circuit Board 220 to slide into each other's rabbet. Then they can be soldered together to make the two Printed Circuit Boards join each other permanently.

Integrated circuit devices for modem telecommunication and data communication applications may operate at frequencies in the range of gigabits per second. Digital signal processing at such high frequencies tends to create interference in different parts of the circuit. The interference between the transmission circuit and the reception circuit are prune to error generation and is especially undesirable. The configuration of the Printed Circuit Boards in the optical transceiver module 100 in the present invention reduces the interference by creating a shield between the transmission circuits and the reception circuits.

As shown in FIG. 3, the second Printed Circuit Board 220 separates the first Printed Circuit Board 210 into two circuit board areas, each of which can include an electronic circuit. In one implementation, a transmission circuitry is disposed in one of the two circuit board areas, and a reception circuitry is disposed in another circuit board area. The second Printed Circuit Board 220 comprises multiple layers, with one of the layers connected to the ground. The ground layer of the second Printed Circuit Board 220 can provide an effective electromagnetic shield between the transmission circuitry and the reception circuitry on the first Printed Circuit Board 210 which minimizes the electromagnetic interference between the high frequency circuitries.

In another embodiment, when the second Printed Circuit Board 220 is assembled into the optical transceiver module 100, its bottom of the second Printed Circuit Board 220 touches the case body 110 of the optical transceiver module 100, and the top of the second Printed Circuit Board 220 is in contact with the sheet metal cover 120 of the optical transceiver module 100. These contacts close the gaps between the second Printed Circuit Board 220 and the case body 110 and its sheet metal cover 120, which further reduces the electromagnetic interference between the transmission and the reception paths.

The Printed Circuit Board configurations described above are compatible with modular shaped applications wherein the module's vertical extension is high enough to allow a second portion of the Printed Circuit Board. In particular, the Printed Circuit Board configuration is applicable to Small Form Factor (SFF) type optical transceiver modules, Small Form-factor Pluggable (SFP) type optical transceiver modules, Bi-directional Small Form-factor Pluaggable (Bi-di SFP) type optical transceiver modules, and other types of optical transceiver modules.

An optical transceiver module having the Printed Circuit Board configuration disclosed in the present invention possesses great advantages over an optical transceiver module having an ordinary Printed Circuit Board. The more usable area allows an optical transceiver module to hold more functions in the module. In addition, the electromagnetic interference between the transmission and reception circuits is reduced.

The first Printed Circuit Board and the second Printed Circuit Board are connected together with mating the two boards along rabbet(s) and soldering. The method is reliable, easy to implement, and cost effective. The method also allows more usable area on the first Printed Circuit Board and compact working space, compared to a mother board/daughter board method.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

Part Numbers

100 optical transceiver module
110 body case of optical transceiver module
120 sheet metal cover of optical transceiver module
130 electrical interface
140 optical interface
210 first Printed Circuit Board
220 second Printed Circuit Board
225 retainer
230 optical transceiver components
240 Upper cover
250 Lower cover
260 Unlocking lever
265 casing pipe
300 Printed Circuit Board
310 first end
320 second end
330 solder joints
410 flexible Printed Circuit Board
510 rabbet
610 rabbet
710 rabbet
720 rabbet

1. An optical transceiver module, comprising
a housing comprising a first end and a second end;
an electrical interface associated with the first end, said electrical interface being adapted to be locked into a socket of a receiving cage;
an optical interface associated with the second end, said optical interface adapted to be connected with one or more optical transceiver components;
a first Printed Circuit Board having a first function circuit connected with the electrical interface; and
a second Printed Circuit Board having a second function circuit that is electrically connected with the first function circuit,
wherein the second Printed Circuit Board is disposed substantially perpendicular to the first Printed Circuit Board.

2. The optical transceiver module of claim 1, wherein the second Printed Circuit Board separates the first Printed Circuit Board into a first circuit and a second circuit,

3. The optical transceiver module of claim 2, wherein the first circuit comprises a transmission circuit and the second circuit comprises a receiving circuit.

4. The optical transceiver module of claim 2, wherein the second Printer Circuit Board provides shielding to the electromagnetic interference between the first circuit and the second circuit.

5. The optical transceiver module of claim 1, wherein the optical transceiver components are directly connected to the first Printed Circuit Board.

6. The optical transceiver module of claim 5, wherein the optical transceiver components are connected to the first Printed Circuit Board through a flexible Printed Circuit Board or by soldering signal pins of the optical transceiver components to the first Printed Circuit Board.

7. The optical transceiver module of claim 1, wherein the first Printed Circuit Board includes a rabbet that is adapted to receive the second Printed Circuit Board.

8. The optical transceiver module of claim 7, wherein the second Printed Circuit Board joins the first Printed Circuit Board by sliding the second Printed Circuit Board into the rabbet on the first Printed Circuit Board.

9. The optical transceiver module of claim 1, wherein the second Printed Circuit Board includes a rabbet that is adapted to receive the first Printed Circuit Board.

10. The optical transceiver module of claim 9, wherein the second Printed Circuit Board joins the first Printed Circuit Board by sliding the first Printed Circuit Board into the rabbet on the second Printed Circuit Board.

11. The optical transceiver module of claim 1, wherein the first Printed Circuit Board includes a rabbet that is adapted to receive the second Printed Circuit Board and the second Printed Circuit Board includes a rabbet that is adapted to receive the first Printed Circuit Board.

12. The optical transceiver module of claim 1, wherein the first Printed Circuit Board and the second Printed Circuit Board are connected by soldering.

13. The optical transceiver module of claim 1, wherein the second Printer Circuit Board comprises multiple layers.

14. The optical transceiver module of claim 1, wherein the second Printer Circuit Board's upper and lower edges are in contact with the sheet metal cover and the optical transceiver module's case body respectively.

15. The optical transceiver module of claim 1, wherein the first Printed Circuit Board comprises
a first end having one or more gold finger typed foil strips in connection with the electrical interface; and
a second end adapted to be connected with one or two optical transceiver components.

16. The optical transceiver module of claim 1 wherein the electrical interface complies with one or more of Small Form Factor agreement (SFF), Small Form factor Pluggable agreement (SFP) and Bi-directional Small Form-factor Pluggable agreement (Bi-di SFP).

17. An optical transceiver module, comprising
a housing comprising a first end and a second end;
an electrical interface associated with the first end, said electrical interface being adapted to be locked into a socket of a receiving cage;
an optical interface associated with the second end, said optical interface adapted to be connected with one or more optical transceiver components; and
a Printed Circuit Board (PCB) module, comprising a first Printer Circuit Board having a first function circuit; and a plurality of second Printed Circuit Boards each comprising a second function circuit that are electrically connected to the first function circuit.

18. The optical transceiver module Printed Circuit Board of claim 17, wherein the second Printed Circuit Boards are connected to the first Printed Circuit Board by one or more rabbets.

19. An optical transceiver module, comprising
a housing comprising a first end and a second end;
an electrical interface associated with the first end, said electrical interface being adapted to be locked into a socket of a receiving cage;
an optical interface associated with the second end, said optical interface adapted to be connected with one or more optical transceiver components;
a first Printed Circuit Board having a first function circuit connected with the electrical interface; and
a multi-layer second Printed Circuit Board comprising a second function circuit in the multi-layer structure, wherein the second Printed Circuit Board is electrically connected with the first function circuit.

20. The optical transceiver module of claim 19, wherein the multi-layer second Printed Circuit Boards are connected to the first Printed Circuit Board by one or more rabbets.
